(19) United States
(12) Patent Application Publication
(10) Pub. No.: US 2010/0269775 A1
(43) Pub. Date: Oct. 28, 2010

(54) SIX-STROKE INTERNAL COMBUSTION ENGINE, METHOD OF OPERATION OF SUCH AN ENGINE AND VEHICLE EQUIPPED WITH SUCH AN ENGINE

(76) Inventors: Karine Chandes, Villeurbanne (FR); Nicolas Dronniou, Lyon (FR)

Correspondence Address: WRB-IP LLP, 801 N. Pitt Street, Suite 123, ALEXANDRIA, VA, 22314, US

(21) Appl. No.: 12/808,218

(22) PCT Filed: Dec. 20, 2007
(86) PCT No.: PCT/IB07/04421

§ 371 Date: Jun. 15, 2010

(51) Int. Cl. F02B 75/02; F02M 25/00

(52) U.S. Cl. 123/1 A

(57) ABSTRACT

A six-stroke internal combustion engine is provided with an injection arrangement adapted to inject into at least one of its cylinders a liquid containing a reductor agent and/or a precursor for a reductor agent. During the fifth and sixth strokes of a piston within the cylinder, this reductor agent can react with NOx molecules in order to clean the gases resulting from the combustion of a fuel mixture within the cylinder.

### BACKGROUND AND SUMMARY

This invention concerns a method of operation of an internal combustion engine during a six-stroke cycle. It also concerns an internal combustion engine designed to operate on a six-stroke cycle and an automotive vehicle equipped with such an engine.

It is known that combustion of a fuel within the cylinders of an internal combustion engine results in the creation of NOx compounds which constitute part of pollutant emissions. Nowadays, designers of internal combustion engines face two major challenges, that is to reduce engine-out pollutant emissions, in order to comply with present and future regulations, and to increase engine efficiency, in order to limit greenhouse effect and fuel consumption.

Several techniques are known to reduce pollutant emissions. They include improvement to after-treatment devices such as SCR devices (selective catalyst reduction), three-way catalysts for NOx reduction, diesel particulate filters for soot emissions, etc. These methods are quite complex and thus expensive.

According to another approach, it is possible to organise the combustion within each cylinder to reduce NOx emissions, in particular by using EGR systems. This decreases the overall efficiency of the engine and increases soot emissions. Specific devices have then to be used to treat soot, which is also complex and expensive. Moreover, some counter pressure is generated, which is non-productive when the engine is running.

Such problems arise with four-stroke and six-stroke internal combustion engines. U.S. Pat. No. 6,571,749 discloses a method of operation of a six-stroke internal combustion engine where one injects into a cylinder of the engine some water when the piston reaches TDC after a 360° rotation following fuel ignition. The injected water is vaporised because of the temperature within the cylinder and its expansion helps the piston moving away from the cylinder head. Water injection has no substantial effect on the pollutant emissions.

DE 34 06 732 discloses a six-stroke cycle where fuel is injected during a second and a fourth stroke.

This invention aims, according to an aspect thereof, at providing a method of operation of an internal combustion engine which takes benefit of a six-stroke cycle in order to reduce NOx emissions.

To this purpose, an aspect of the invention concerns a method of operation of an internal combustion engine during a six-stroke cycle, this method comprising at least the following steps

a) intake of a gas mixture into at least a cylinder during a first stroke of a piston movable within this cylinder
b) compression of this gas mixture within this cylinder, during a second stroke of the piston
c) ignition of a fuel mixture, comprising fuel and said gas mixture, when the piston is near its top dead centrer position, for the first time in its cycle
d) expansion of burnt gases resulting from the combustion of said fuel mixture, within the cylinder which is kept closed, during a third stroke of the piston
e) compression of the burnt gases within the cylinder which is kept closed, during a fourth stroke of the piston
f) injection of a liquid, containing a reductor agent and/or a precursor for a reductor agent, into the cylinder when the piston is near its top dead center position, for the second time in the cycle
g) expansion of a mixture of burnt gases and vapor resulting from the vaporisation of the liquid, during a fifth stroke of the piston and
h) opening of at least an exhaust valve of the cylinder and expulsion of the mixture out of the cylinder through the opened exhaust valve, during a sixth stroke of the piston.

According to an aspect of the invention, the redactor agent is gaseous ammonia or its precursor urea or liquid ammonia. The liquid injected at step f) is an aqueous solution of the redactor agent and/or the precursor.

A reductor agent, which is sometimes called “reductant agent” or “reducing agent”, is a chemical entity or compound which reduces, or lowers, the state of oxidation of other chemical compounds or entities. In the particular application concerned, it is a chemical entity or compound which promotes reductions of pollutant emissions thanks to chemical reactions. A precursor for a reductor agent is a chemical entity which, by its decomposition, gives a reductor agent.

Thanks to an aspect of the invention, soot emissions resulting from the combustion of the combustible fuel are largely oxidised during the upward stroke of the piston when they are compressed during the fourth stroke of step e), because of the combination of the high temperature in the cylinder, the high residence time and the available oxygen. Because of the high temperature within the cylinder, the liquid injected at step f) is vaporised and expands in the internal volume of the cylinder, which creates some positive power on the piston, during its downwardly oriented fifth stroke. Moreover, when the injected liquid includes a precursor for a reductor agent, it is vaporized and one or several reductor agent(s) are formed by its chemical decomposition. Alternatively, the reductor agent(s) present in the injected liquid are vaporized without decomposition of a precursor. Then, there happens chemical reactions of this or these agent(s) with NOx molecules resulting from the fuel combustion, in a way quite similar to selective non-catalytic reduction (SNCR). This process reduces drastically the need to use complex and expensive after treatment devices.

According to further aspects of the invention, the method can incorporate one or several of the following features:
The engine is of the direct fuel injection type and fuel is injected within the cylinder during or at the end of step b). According to another embodiment of an aspect of the invention, the engine is of the indirect fuel injection type, whereas fuel is mixed with the gas mixture outside the cylinder and intake of the fuel mixture takes place during the first stroke.
Liquid injection at step f) takes place when the crankshaft of the engine is between 60° before and 20° after its angular position when the piston is in its top dead centre position for the second time in its cycle. In other words, step f) occurs on a limited angle range around when the piston reaches TDC for the second time in the cycle. This limited angle range advantageously lies between 20° and 60°.

The water used to prepare the aqueous solution injected at step t) comes advantageously from the condensation of exhaust gases of the engine in an EGR system.

The liquid injected at step f) is obtained by mixing solid urea with water.

An aspect of the invention also concerns an internal combustion engine designed to operate on a six-stroke cycle according to the method noted above, this engine comprising at least one cylinder and a piston slidable within this cylinder. This engine is characterised in that it includes injection means adapted to inject into the cylinder a liquid containing a reductor agent and/or a precursor for a reductor agent. According to further aspects of the invention, such an engine might incorporate one or several of the following features:

The injection means are also adapted to inject fuel into the cylinder. In such a case, a dual feeding system advantageously feeds the injector means with fuel and with the liquid containing the reductor agent and/or the precursor.

According to an alternative embodiment of the injection, the internal Combustion engine includes a first injector dedicated to fuel injection and a second injector dedicated to the injection of the liquid containing the reductor agent and/or the precursor.

The engine can be a Diesel engine, preferably with direct injection, or a gasoline spark ignited engine with direct or indirect fuel injection.

An aspect of the invention also concerns an automotive vehicle equipped with an internal combustion engine as mentioned here-above. Such a vehicle is more environmental-friendly than the ones of the prior art, without being substantially more expensive.

### BRIEF DESCRIPTION OF THE DRAWINGS

The invention will be better understood on the basis of the following description, which is given in correspondence with the annexed figures and as an illustrative example, without restricting the object of the invention. In the annexed figures:

FIG. 1 is a schematic view of an engine according to the invention mounted on a truck according to the invention.

FIG. 2 is a schematic view of a cylinder of the engine of FIG. 1 during a first stroke of its piston in a six-stroke cycle.

FIG. 3 is a view similar to FIG. 2 when the piston is in a second stroke of its cycle.

FIG. 4 is a view similar to FIG. 2 when the piston is in its top dead center position for the first time in its cycle.

FIG. 5 is a view similar to FIG. 2 when the piston is in its third stroke in the cycle.

FIG. 6 is a view similar to FIG. 2 when the piston is in its fourth stroke in its cycle.

FIG. 7 is a view similar to FIG. 2 when the piston is in its top dead center position for the second time in its cycle.

FIG. 8 is a view similar to FIG. 2 when the piston is in its fifth stroke in its cycle and

FIG. 9 is a view similar to FIG. 2 when the piston is in its sixth stroke in its cycle.

### DETAILED DESCRIPTION

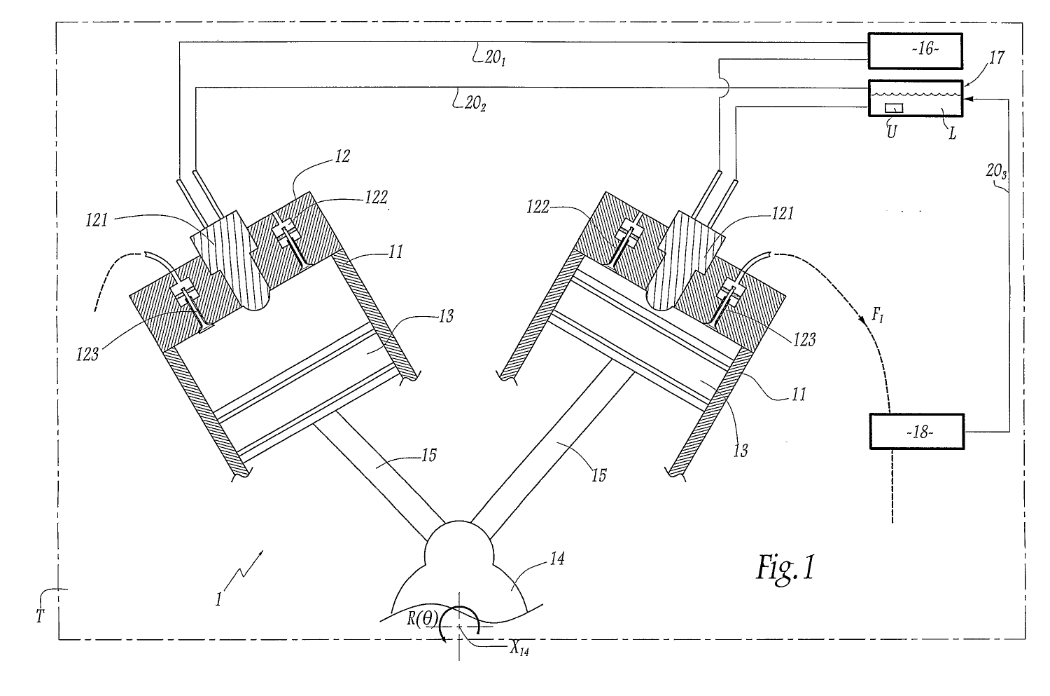

The Diesel engine 1 represented on FIG. 1 is mounted on a truck T and includes several cylinders 11, each provided with a cylinder head 12 and a piston 13 sliding within the cylinder and connected to a crankshaft 14 of the engine, via a respective connecting rod 15.

Crankshaft 14 rotates around an axis Xi4, as shown by arrow R, and its angular position about this axis is measured by an angle θ.

Two cylinders 11 are represented on FIG. 1. Actually, the numbers of cylinders of engine 1 depends on the power to be delivered by the engine and can be for instance of six or eight cylinders, disposed in line or in a V shape configuration, as shown on FIG. 1.

The engine illustrated is of a direct fuel injection type, so that each cylinder 12 is provided with a fuel injector 121, as well as with at least one intake valve 122 and at least one exhaust valve 123. In fact, each cylinder head 12 can be provided with several intake valves 122 and/or several exhaust valves 123.

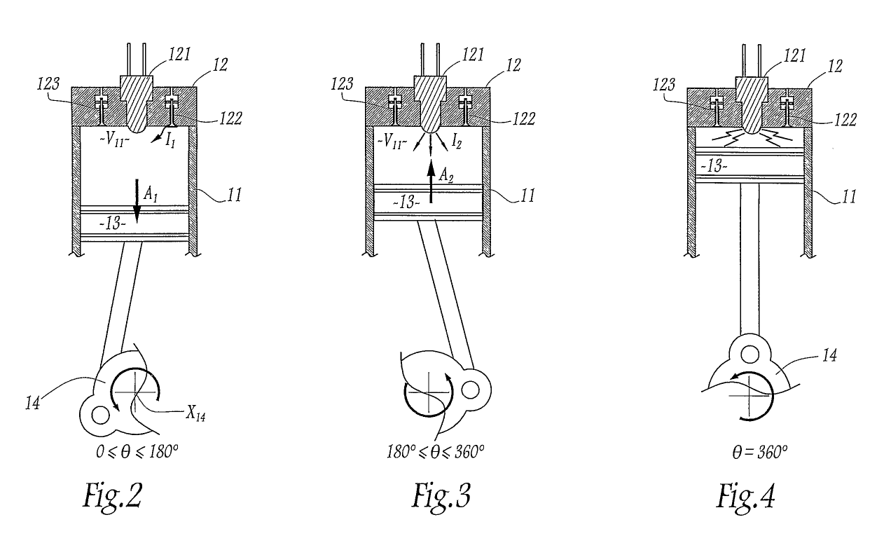

Engine 1 is designed to operate on a six-stroke cycle shown on FIGS. 2 to 7 for one of the cylinders 11. One considers here that this cycle starts when the angular position of the crankshaft 14 is when angle θ equals 0.

In the following description, a downward movement of its piston 13 is a movement of the piston away from cylinder head 12, which corresponds to an expansion of the internal volume Vn of the cylinder. Conversely, an upward movement of piston 13 is directed towards head 12 and corresponds to a diminution of volume Vn.

In a first-stroke of the method, θ increases from 0° to 180° and piston 13 moves away from the cylinder head 12 while intake valve 122 is open and exhaust valve 123 is closed. A mixture of gases, which includes fresh air and, possibly, exhaust gases coming from an EGR system, is drawn within the internal volume Vn of cylinder 11 which is at low pressure because of the downwardly oriented movement of piston 13 shown by arrow Ai on FIG. 2. In other words, intake of the gas mixture takes place during the first stroke of piston 13, as shown by arrow h.

Intake h of the gas mixture into volume Vn takes place during all the first stroke, that is when angle θ lies between 0 and 180°. During the second stroke of piston 13 shown on FIG. 3, intake and exhaust valves 122 and 123 are closed and, as the piston 13 moves towards cylinder head 12 as shown by arrow A2, the gases trapped within volume Vn are compressed. During this compression, the gases are heated up to a high temperature.

During this second stroke, angle θ increases from 180° to 360°. Before piston 13 reaches TDC, at θ=360°, fuel injection is initiated by injector 121, as shown by arrows 12, whereas valves 122 and 123 remain closed. In the case of a Diesel direct injection engine, fuel injection \z starts when angle θ is about 360° and lasts about 15° to 25°. In the case of a Diesel engine operating under homogeneous charge compression ignition (HCCI), or of a gasoline engine with direct fuel injection, the injection may start a little earlier. A fuel mixture is formed, which includes the gas mixture drawn in cylinder 12 during the first stroke, as shown by arrow Ii, and the fuel injected at the end of the second stroke, as shown by arrows 12.

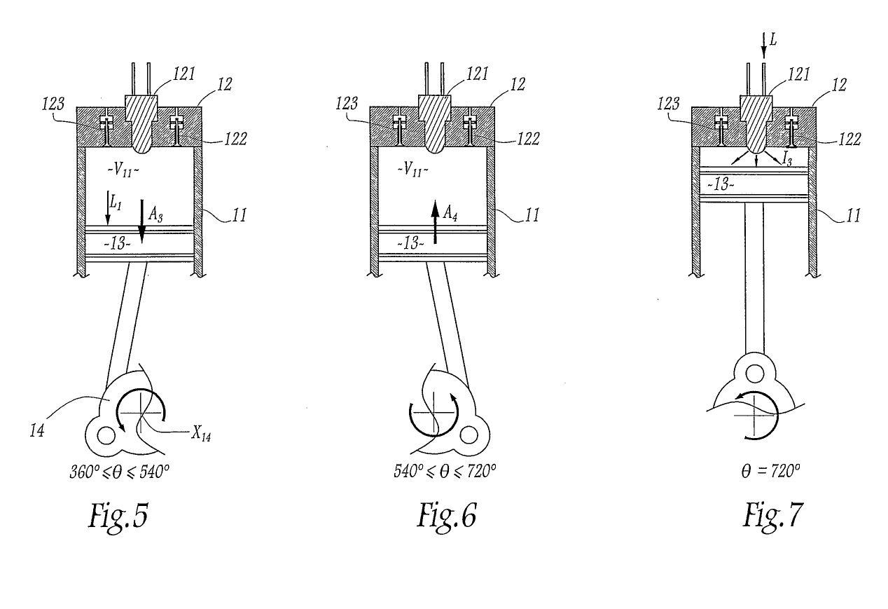

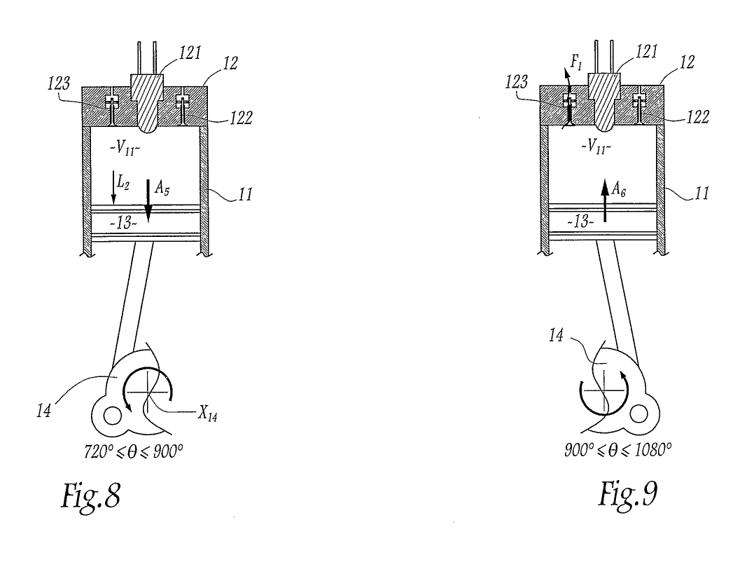

When piston 13 reaches TDC, at θ=360°, gas pressure and temperature within cylinder 12 are such that auto-ignition of the fuel mixture takes place. Because of the auto-ignition, the fuel mixture trapped within volume burns at high temperature and expands, which creates a load Li on piston 13. This helps the downward movement of piston 13 during the third stroke, shown by arrow A3 on FIG. 5, and induces the transmission of a positive power to crankshaft 14. During this third stroke, angle θ increases from 360° to 540°.

In the fourth stroke of the cycle represented on FIG. 6, angle θ increases from 540° to 720° and valves 122 and 123 are kept closed. During the movement of piston 13 towards cylinder head 12, shown by arrow A4, a compression of the burnt gases take place within volume Vn. The soot particles which were created during the combustion of the fuel after ignition at TDC are largely oxidised during this stroke because of the high temperature prevailing in volume Vn. Actually, the burnt gases and soot particles remain exposed to oxygen within volume VII during the movement of crankshaft 14 corresponding to the increase of angle θ from 360° to 720°.

When piston 13 reaches TDC for the second time in its cycle, that is when angle θ equals about 720° as shown on FIG. 7, one injects a predetermined quantity of an aqueous solution of urea within volume V11, as shown by arrows 13.

Because of the high temperature prevailing in volume Vn, this solution is quickly vaporised after its injection.

Injection 13 of the water/urea solution takes place via injector 121 during a short period of time when piston 13 is near TDC. Injection 13 can start when angle θ is comprised between 700° and 740°. In other words, injection of the water/urea solution can start as soon as the crankshaft is in an angular position 20° prior to its position at second TDC It could even start earlier, up to 60° prior to second TDC. The duration of the injection 13 can vary for example between 15 to 60 degrees of crankshaft revolution.

Urea is a precursor for a reductor agent, namely gaseous ammonia, for the NOx molecules contained in the burnt gases and trapped within volume V11. Instead of a water/urea solution, one can inject, in the step of FIG. 7, liquid containing another precursor for a reductor agent, like liquid ammonia. Alternatively, the liquid L can also include a reductor agent instead of, or in addition to, the precursor.

The liquid containing the reductor agent is a water-based solution. Because of its high water content and of the high temperature within volume Vn, this solution vaporises quickly within volume VII after its injection 13.

After the step of FIG. 7, the vaporised solution occupies volume VII and expands, thus creating a second load L2 on the piston 13 which moves away from the cylinder head 12, as shown by arrow A5, during its fifth stroke where angle θ increases from 720° to 900°. Positive power is therefore transmitted to crankshaft 14.

During this fifth stroke, the ammonia gaseous molecules deriving from the vaporisation and chemical decomposition of the aqueous urea solution react with the NOx molecules resulting from the combustion of the fuel mixture This reaction transforms some NOx molecules into N2 and H2O molecules which are more environmental-friendly.

In other words, a chemical reaction occurs between the gaseous ammonia molecules and the NOx molecules in a way similar to what exists in selective non-catalytic recution, which substantially decreases the NOx content of the exhaust gases of engine 1

During the sixth stroke of the cycle, when angle θ increases from 900° to 1080° and as shown on FIG. 9, piston 13 moves towards cylinder head 12, in the direction of arrow A6 and exhaust valve 123 is open, so that piston 13 pushes the exhaust gases treated by interaction with the reductor agent out of volume Vn, which creates a flow F1 out of cylinder 11.

This flow Fi is then directed to an exhaust gas manifold and to the exhaust line of engine 1, without a need, or with a limited need, to use selective catalytic reduction (SCR) devices, or other after treatment devices. With the method of an aspect of the invention, interaction of the reductor agent molecules, namely gaseous ammonia, with the NOx molecules takes place in the cylinder from the beginning of injection 13, with 0 between 660° and 720°, until the end of the sixth stroke, at θ=1080°. Therefore, the chemical reaction between the reductor agent and the NOx molecules can be fairly complete. This relatively long angular range, typically more than 380°, which corresponds to a relatively long time period, is much more favourable for the chemical reaction than what could be obtained if one were to inject ammonia or another reductor agent in a cylinder in a four-stroke engine.

Reaction between the reductor agent and the NOx molecules takes place in a closed volume during a fifth stroke of piston 13 and in an open volume during its sixth stroke.

In the method explained here-above, injector 121 is used to feed the internal volume Vn of cylinder 11 with fuel and with the liquid L. This is advantageous in so far as one does not need to create specific injector means for the liquid containing the reductor agent and/or its precursor.

In order for the injector 121 to fulfil this double function, it is fed by a first line 201 connected to an pressurized fuel source 16. Injector 121 is also connected, by a second line 202, to a reservoir 17 storing the liquid L containing the reductor agent and/or its precursor.

Alternatively, each cylinder 11 of the engine 1 of an aspect of the invention can be equipped with two injectors, namely a first injector dedicated to fuel injection, and a second injector dedicated to the injection of the liquid L which contains a reductor agent and/or a precursor for such an agent

According to an advantageous aspect of an aspect of the invention, the water used to create the solution containing the reductor agent is obtained by the condensation of exhaust gases of engine 1 going through an EGR system 18. This condensed water is sent by a line 203 to reservoir 17 where it comes into contact with a block U of solid urea. This results in an aqueous solution of urea.

Of course, other ways of obtaining the aqueous reductor agent and/or precursor solution can be considered.

According to another alternative embodiment of an aspect of the invention, several reductor agents can be used at the same time. The liquid L used in such a case includes several precursors and/or several reductor agents.

An aspect of the invention has been represented when used with a Diesel engine. However, it can also be used with regular gasoline or gaz engines where ignition of the fuel mixture is spark-ignited, that is results from the assistance of a spark plug. In case of an engine having direct fuel injection, as seen above, fuel is injected within each cylinder 11 during or at the end of the second stroke. In case of a gasoline engine with indirect injection, fuel is mixed with the gas mixture outside each cylinder 11 and intake of the fuel mixture, including the gas mixture and the fuel, takes place during a first stroke, via the intake valve 122. In all such engines, injection 13 of the liquid L containing a reductor agent and/or a precursor for such a reductor agent takes place as explained here-above for a Diesel engine, namely when the piston 13 is near its top dead center position for the second time in its cycle.

Thanks to an aspect of the invention, six-stroke internal combustion engine 1 is provided with injection means 121 adapted to inject into one of its cylinders 11a liquid L containing a reductor agent and/or a precursor of a reductor agent, such as urea.

During the fifth and sixth strokes A5 and A& of the piston 13, within this cylinder 11, this reductor agent can react with NOx molecules in order to clean the gases resulting from the combustion of a fuel mixture within this cylinder.

1. A method of operation of an internal combustion engine during a six-stroke cycle, the method comprising at least the following steps:
a)—intake of a gas mixture into at least a cylinder, during a first stroke (Ai) of a piston movable within the cylinder
b)—compression of the gas mixture within the cylinder, during a second stroke (A2) of the piston
c)—ignition of a gas mixture, comprising fuel and the gas mixture, when the piston is near its top dead center position, for the first time (θ=360°) in the cycle
d)—expansion of burnt gases, resulting from the combustion of the fuel mixture, within the cylinder which is kept closed, during a third stroke of the piston
e)—compression of the burnt gases within the cylinder which is kept closed, during a fourth stroke of the piston
f)—injection of a liquid, containing a reductor agent and/or a precursor (U) for a reductor agent, into the cylinder when the piston is near its top dead center position for the second time (θ=720°) in the cycle
g)—expansion of a mixture of burnt gases and vapor resulting from the vaporization of the liquid, during a fifth stroke (A5) of the piston, and
h)—opening of at least an exhaust valve of the cylinder and expulsion of the mixture out of the cylinder through the opened exhaust valve, during a sixth stroke (A6) of the piston
wherein at least one of
1) the precursor is urea or liquid ammonia,
2) the redactor agent is gaseous ammonia, and
3) the liquid is an aqueous solution of at least one of urea, liquid ammonia, and gaseous ammonia.

2. Method according to claim 1, wherein the engine is of the direct fuel injection type and fuel is injected within the cylinder during or at the end of step b).

3. Method according to claim 1, wherein engine is of the indirect fuel injection type, wherein fuel is mixed with the gas mixture outside the cylinder and wherein intake of the fuel mixture takes place during the first stroke.

4. Method according to claim 1, wherein liquid injection at step f) starts when a crankshaft (14) of the engine is between 60° before and 20° after its angular position (θ=720°) when the piston is in its top dead center position for the second time in the cycle.

5. Method according to claim 4 wherein liquid injection takes place on a range of angular positions of the crankshaft between 15° and 60°.

6. (canceled)

7. (canceled)

8. (canceled)

9. Method according to claim 8, wherein the water used to prepare the solution comes from the condensation of exhaust gases of the engine in an EGR system.

10. Method according to claim 1 wherein the liquid is obtained by mixing solid urea with water.

11. An internal combustion engine designed to operate on a six-stroke cycle according to the method of one of the previous claims, the engine comprising at least one cylinder and a piston slidable within the cylinder, wherein the engine includes injection means adapted to inject into the cylinder a liquid containing a reductor agent and/or a precursor for a reductor agent.

12. Internal combustion engine according to claim 11, wherein the injection means are also adapted to inject fuel into the cylinder.

13. Internal combustion engine according to claim 13 wherein a dual feeding system feeds the injection means with fuel and with the liquid.

14. Internal combustion engine according to claim 11 wherein it includes a first injector dedicated to fuel injection and a second injector dedicated to the injection of the liquid containing the reductor agent and/or the precursor.

15. Internal combustion engine according to claim 11, wherein it is a Diesel engine.

16. Internal combustion engine according to claim 11, wherein it is a spark-ignited regular gasoline engine

17. Automotive vehicle, in particular industrial vehicle, equipped with an internal combustion engine according to claim 11.
